(19) United States
(12) Patent Application Publication
(10) Pub. No.: US 2017/0301491 A1
(43) Pub. Date: Oct. 19, 2017

(54) THREE-POSITION VACUUM SWITCH FOR REALIZING EXTERNAL GROUNDING OF LOAD SIDE BY USING CONNECTED BUSBAR

(71) Applicant: SHENYANG HUADE HIGH TECHNOLOGY ELECTRIC CO., LTD., Liaoning (CN)

(72) Inventors: Jiaosuo ZHANG, Liaoning (CN); Tao CHEN, Liaoning (CN); Jiayao WANG, Liaoning (CN); Shizheng GUO, Liaoning (CN)

(21) Appl. No.: 15/510,240

(22) PCT Filed: Sep. 8, 2015
(86) PCT No.: PCT/CN2015/089125

§ 371 Date: Mar. 10, 2017

(30) Foreign Application Priority Data
Nov. 12, 2014 (CN) 201410632090.6

(51) Int. Cl. H01H 33/666; H01H 33/664

(52) U.S. Cl. CPC H01H 33/666; H01H 33/664; H01H 2205/002; H01H 2235/01; H01H 2221/036

(57) ABSTRACT

A three-position vacuum switch for realizing external grounding of a load side by using a connected busbar overcomes the problems in the prior art that load side grounding is realized depending on the opening and closing of a vacuum arc extinguishing chamber, a misoperation easily occurs because an operator cannot see the grounding situation intuitively, and when an operating mechanism machine has a problem, it needs to have a grounding line plugged in externally, which cause inconvenient operations and huge safety risks, characterized in that a connected busbar is hinged on front and back sides of a load socket, the vacuum arc extinguishing chamber is connected to the connected busbar by using a pin, the connected busbar is electrically connected to a grounding socket to realize primary grounding, and the vacuum arc extinguishing chamber is electrically connected to the grounding socket to realize auxiliary grounding.

### BACKGROUND OF THE INVENTION

The invention belongs to the field of switching technology equipment, particularly relates to a three-position vacuum switch for realizing load-side external grounding utilizing connecting busbar.

The existing vacuum switch comprises the buses, a vacuum interrupter, a load conductor, a grounding conductor and a three-position switch (an isolated position, a middle position and a grounding position) and an operating mechanism. The vacuum interrupter is driven by the operating mechanism to realize the breaking of the line buses.

Application Number: CN200710103519.2. Corresponding invention patent with Application Number: US20060360273 discloses a three-position vacuum switch for providing current interruption, isolation and grounding, comprising the line buses, a vacuum interrupter, a load conductor, a grounding conductor and an operating mechanism. The vacuum interrupter comprises a static conductor, a moving conductor and an insulating cylinder, wherein, the static contacts and the moving contacts are positioned in the insulating cylinder; the moving contacts can be moved between the position where the static contacts are electrically connected to the closed circuit and the position where the static contacts are separated with the turn-off circuit; the load conductor is electrically connected to the moving conductor: the structure of operating mechanism is: (a) to realize the making and switching of circuit by contacting and breaking of moving contacts and static contacts, and (b) to move the vacuum interrupter between the first position (i.e. the circuit conducting position) and the second position (i.e. the load-side grounding position), wherein, the static contacts are electrically connected to the circuit buses at the first position and the static conductor is electrically connected to the grounding conductor. Combined with its FIGS. 3D, 3E, 4D and 4E, it shows that when the load-side conductor is grounding, first, the vacuum interrupter is broken, then the vacuum interrupter is rotated to the position where the static conductor and the grounding conductor are connected, and then the vacuum interrupter is switched on, to realize the load-side grounding. However, there is a problem: that the operator cannot visually see the ground situation arising from misuse because the vacuum interrupter is completely closed in load grounding process. And when there is a problem in mechanical or electrical operating mechanism, the closing grounding cannot be realized and the plug grounding wires are required, so that the operation is trouble and inconvenient with greater security risks; and combined with its FIGS. 6B and 6C, it shows that the same is that the vacuum interrupter is broken first, and then the vacuum interrupter vertically downward moved to that the static conductor is connected with the grounding conductor, and then the vacuum interrupter is closed, to realize the load-side grounding, above of all having the same problems. After the static conductor is connected with the ground conductor utilizing the technical scheme, the vacuum interrupter will appear shocks when it is reclosed, to ensure that vacuum interrupter is well fixed and will not appear shock when it is closed, and the external holding device is required, but its structure is complex with high costs.

In addition, in the conventional vacuum switchgear, since the vacuum interrupter is not only to withstand the function of breaking current, but also to withstand the insulation withstand voltage function, which lead prone NSDD (non-holding disruptive discharge) phenomenon, affecting the security of the device.

### BRIEF SUMMARY OF THE INVENTION

The technical problem to be solved by the utility model is: to overcome the shortcomings and defects on the invention; to provide a three-position vacuum switch for realizing load-side external grounding utilizing connecting busbar which have the advantage of simple, low costs, high security, that the load-side external grounding process can be visually seen by the operator, and avoids the vacuum interrupter shock occurs.

The technical scheme of the utility model comprises a conductive seat, a vacuum interrupter, a load seat, a grounding seat and a drive shaft. The connecting busbar is hinged in the front and rear sides of the load seat. The end of the connecting busbar is fixedly connected with the drive shaft, and the top of the section outside the insulating cylinder exposed to the moving conductor of the vacuum interrupter is connected with the connecting busbar by pin shaft. The return spring is arranged between the pin shaft and moving conductor. The limit spring is arranged on the movable end of connecting busbar.

The rotating vacuum interrupter and connecting busbar realize the main line breaking and the functions of three-position switch. The connecting busbar and grounding seat are electrically connected to realize the main grounding. The vacuum interrupter and grounding seat are electrically connected to realize the auxiliary grounding.

When the static plug on the static conductor of the vacuum interrupter is positioned between the conductor seat and the grounding seat, a middle position (i.e. an isolation position and a grounding position) is formed on the three-position switch. A visual grounding fracture is formed on the three-position switch between the static plug on the static conductor and the grounding seat.

The vacuum interrupter is separated from the conductive seat to realize the isolation position, as well as to realize the self-closing under the self-closing forces and to realize the reset after breaking relying on the return spring and the limit spring.

The vacuum interrupter breaking and connecting busbars rotation in realizing of the functions of three-position switch are driven by a driving mechanism.

The vacuum interrupter is to only withstand the breaking process. The insulating gas is to withstand the power frequency and lightning impulse withstand voltage.

Compared with the present invention, the invention has the beneficial effects that:

(1) The invention realizes the breaking of the main buses and the functions of three-position switch utilizing the rotation connecting buabar and the vacuum interrupter. In addition, the invention realizes the load-side external grounding utilizing the connecting busbar, i.e. main grounding; the utilizing procedures can be visually seen by the operator. The vacuum interrupter breaking and connecting busbars rotation in realizing of the functions of three-position switch are driven by a driving mechanism. It has the advantages of simple structure, easy operation, and it is more reliable for closing ground than vacuum interrupter.

(2) The invention also comes with auxiliary grounding, when the connecting busbar and is connected to grounding seat, the vacuum interrupter will be automatically closed under the self-closing forces, to realize the auxiliary grounding, and this procedure is not same as the background technology patent of first grounding the static conductor and closing the vacuum interrupter to realize the load grounding, it is safe, reliable, easy to operate.

(3) The invention realizes the reliable load-side grounding manually when there is a problem in mechanical or electrical operating mechanism, resulting in failed grounding.

(4) Since the bridge switch of the invention has a supporting and fixation role on the vacuum interrupter, the holding device can be cancelled so that structure becomes simple and costs are reduced.

(5) The vacuum interrupter of the invention is to withstand only the breaking process, and the vacuum interrupter and the insulating gas are to only jointly withstand the power frequency and lightning impulse withstand voltage after breaking, greatly reducing the probability of NSDD (non-holding disruptive discharge) phenomenon.

### BRIEF DESCRIPTION OF THE DRAWINGS

FIG. 1 is a diagram of the line conducting structure of the invention;

FIG. 2 is a top view of FIG. 1;

FIG. 3 is a diagram of the lines of the invention in breaking and in isolation closing, and to be opened;

FIG. 4 is a diagram of the lines of the invention in breaking and the vacuum interrupter in self-closing.

FIG. 5 is a diagram of the lines of the invention in breaking and the vacuum interrupter reset.

FIG. 6 is a diagram of the lines of the invention in breaking and in the load-side grounding.

As shown in FIGS.

1. Conductive pads;

2. Vacuum interrupter;

2-1. Static conductor; 2-1-1. Static plug; 2-2. Static contact;

2-3. Moving conductor; 2-4. Moving contact;

2-5 Insulating cylinder; 2-6. Static cover;

2-7. Moving cover; 2-8. Bellows;

3. Load seat; 4. Connecting busbar; 5. Grounding seat; 6. Driving shaft;

7. Pin shaft; 8. Return spring; 9. Limit spring;

### DETAILED DESCRIPTION OF THE INVENTION

The embodiments of the invention are given in FIGS.

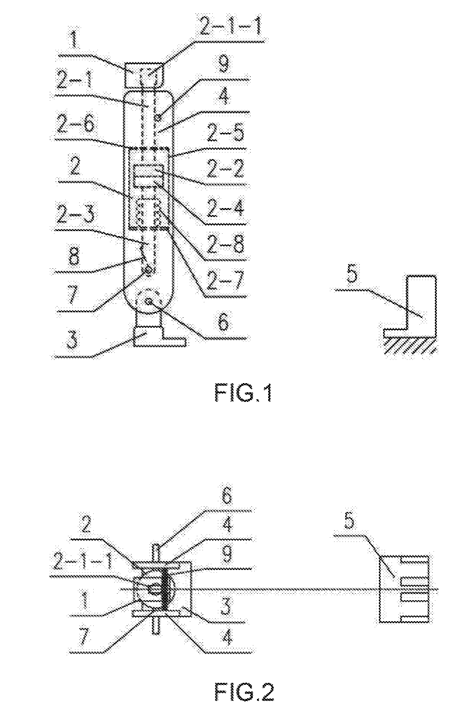

As shown in FIG. 1 and FIG. 2, the invention comprises a conductive seat 1, a vacuum interrupter 2, a load seat 3, a grounding seat 5 and a drive shaft 6; the connecting busbar 4 is hinged in the front and rear sides of the load seat 3; the end of the connecting busbar 4 is fixedly connected with the drive shaft 6, and the connecting busbar rotates with the center of driving shaft 6 under the action of operating mechanism; the vacuum interrupter 2 is composed a moving conductor 2-3, the moving contacts 2-4 and the static conductor 2-1, the static contacts 2-2, a insulation cylinder 2-5, a static cover 2-6, a moving cover 2-7 and bellows 2-8; the moving conductor 2-3 and moving contacts 2-4 are welded into a whole, and the part of moving conductor 2-3 is exposed outside the insulating cylinder 2-5; the top of the section outside the insulating cylinder 2-5 exposed to the moving conductor 2-3 is connected with the connecting busbar 4 by pin shaft 7; the return spring 8 is arranged between the pin shaft 7 and moving conductor 2-3; the end of the reset spring 8 is connected to the pin shaft 7 and the other end is connected to the moving conductor 2-3; also the limit spring 9 is arranged on the movable end of connecting busbar 4; the section of the moving conductor 2-3 welded with the moving contacts 2-4 is positioned in the insulating cylinder 2-5; the moving cover 2-7 is welded at the lower end of the insulating cylinder 2-5; also the bellows 2-8 are welded between the moving cover 2-7 and the moving conductor 2-3 to form a sealing structure; the static conductor 2-1 and the static contacts 2-2 are welded into a whole; and the part of the static conductor 2-1 is exposed outside the insulating cylinder 2-5; the static conductor contacts 2-1-1 are welded at the top of the section outside the insulating cylinder 2-5 exposed to the static conductor 2-1; the section of static conductor 2-1 welded with the static contacts 2-2 is positioned in the sealing insulating cylinder 2-5; the static cover 2-6 is welded at the upper end of the insulating cylinder 2-5; the static conductor 2-1 is welded in the center hole on the static cover 2-6 to form a sealing structure; the vacuum interrupter 2 is in vacuum state when using; the moving contacts 2-4 move in the insulating cylinder 2-5 in a straight line driven by the moving conductor 2-3, to realize line breaking and conducting;

As shown in FIG. 5, an isolating fracture is formed on the three-position switch between the conductive seat 1 and the static plug 2-1-1 on the static conductor 2-1; when the static plug 2-1-1 on the static conductor 2-1 is positioned between the conductor seat 1 and the grounding seat 5, a middle position (i.e. an isolation position and a grounding position) is formed on the three-position switch. A visual grounding fracture is formed on the three-position switch between the static plug 2-1-1 on the static conductor 2-1 and the grounding seat 5; when the static conductor contacts 2-1-1 on the static conductor 2-1 are positioned between the line contacts 1-1 on the line buses 1 and the grounding static contacts 4-1-1 on the grounding static conductor 4-1, a middle position (i.e. an isolation position and a grounding position) is formed on the three-position switch; a visual grounding fracture is formed on the three-position switch between the static conductor contacts 2-1-1 on the static conductor 2-1 and the grounding static contacts 4-1-1 on the grounding static conductor 4-1.

The vacuum interrupter 2 is to only withstand the breaking process. The insulating gas is to withstand the power frequency and lightning impulse withstand voltage.

Utilizing procedures are described as below.

Step in FIG. 1 shows a conducting state; the vacuum interrupter 2 is in the closing position; the conductive seat 1 and the static plug on the static conductor 2-1 are plug-connected to realize the three-position switch isolation;

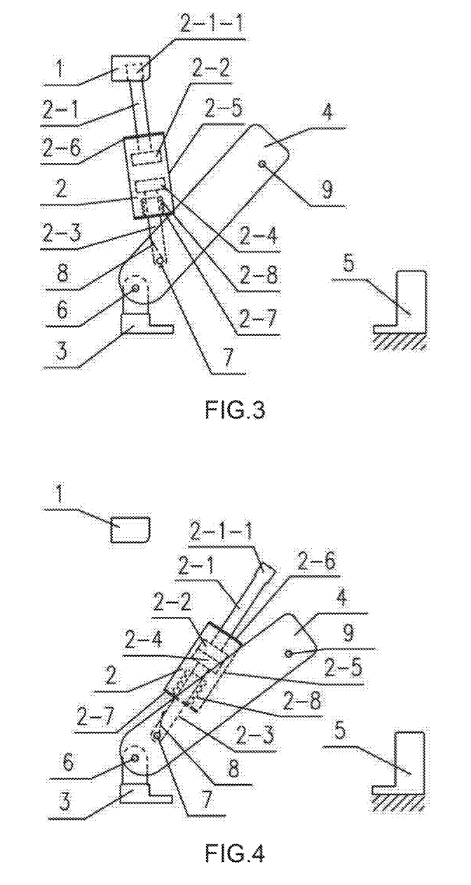

Step 2 in FIG. 3 shows a state of lines in breaking, in isolation closing, and to be opened; at this time, the connecting busbar 4 rotates to the middle position, and the moving contacts 2-4 and the static contacts 2-2 are opened, so that the lines are in breaking; the load-side is not charged, three-position switch is still in isolation closing and to be opened, that is the static plug 2-1-1 on the static conductor 2-1 and the conductive seat 1 are to be released and opened.

Step 3 in FIG. 4 shows a state of lines of the invention in breaking and the vacuum interrupter in self-closing; the three-position switch in the middle position, i.e. isolation positing and grounding position; at this time, the static plug 2-1-1 on the static conductor 2-1 and the conductive seat 1 are thoroughly opened to realize the isolation position; as well as to make the vacuum interrupter 2 move to the connecting busbar 4 under the action of the return spring 8; to realize the self-closing under the self-closing forces;

Step 4 in FIG. 5 shows is a state of the lines of the invention in breaking and the vacuum interrupter reset; at this time, the vacuum interrupter 2 rotates to the connecting busbar 4 parallel, i.e. the vacuum interrupter reset state, and the will not overshoot ensured by limit spring 9 when the vacuum interrupter 2 is reset and will not rebound ensured by limit spring 9 after the vacuum interrupter 2 is reset;

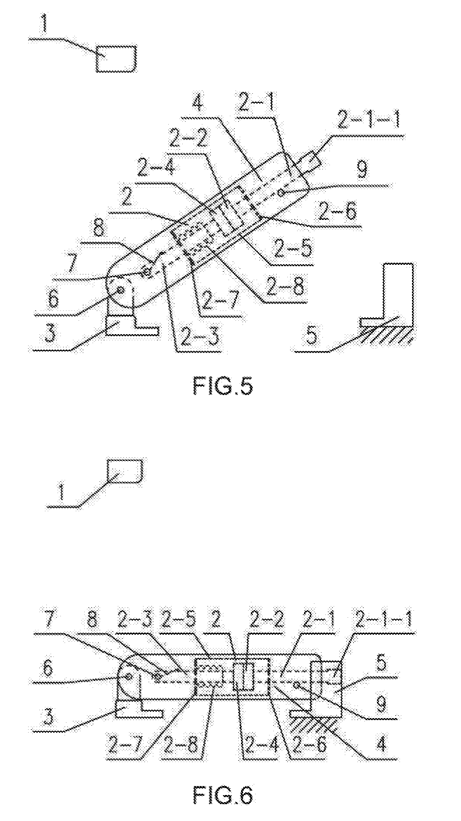

Step 5 in FIG. 6 shows a state of the lines of the invention in breaking and in the load-side grounding; at this time, the static plug 2-1-1 on the static conductor 2-1 is connected with the connecting busbar 4 and the grounding seat 5, to realize the load grounding, i.e. three-position switch grounding closing position, not only realizing the main grounding with the connecting busbar 4 as the external grounding, i.e. the operator visual grounding, but also realizing the auxiliary grounding with the vacuum interrupter 2 as the internal grounding, thereby omitting the cited patents the last step of CN200710103519.2, that is, after the static conductor is grounded, and then the vacuum interrupter is closed to realize the load grounding, so this patent is not only has the main operator visual grounding, but also has the self-closing auxiliary grounding of vacuum interrupter, so that the invention is safe and reliable and its structure is simple.

The conductive seat 1, static conductor 2-1, static plug 2-1-1, static contact 2-2, moving conductor 2-3, moving contacts 2-4, load seat 3, connecting busbar 4, grounding seat 5 are all good conductors.

What is claimed is:

1. A three-position vacuum switch for realizing load-side external grounding utilizing connecting busbar comprising a conductive seat (1), a vacuum interrupter (2), a load seat (3), a grounding seat (5) and a drive shaft (6), is characterized in that: The connecting busbar (4) is hinged in the front and rear sides of the load seat (3); the end of the connecting busbar (4) is fixedly connected with the drive shaft (6), and the top of the section outside the insulating cylinder (2-5) exposed to the moving conductor (2-3) of the vacuum interrupter (2) is connected with the connecting busbar by pin shaft; the return spring (8) is arranged between the pin shaft (7) and moving conductor (8); the limit spring (9) is arranged on the movable end of connecting busbar (4).

2. A three-position vacuum switch for realizing load-side external grounding utilizing connecting busbar of claim 1 is characterized in that: The rotating vacuum interrupter (2) and connecting busbar (4) realize the main line breaking and the functions of three-position switch; the connecting busbar (4) and grounding seat (5) are electrically connected to realize the main grounding; the vacuum interrupter (2) and grounding seat (5) are electrically connected to realize the auxiliary grounding.

3. A three-position vacuum switch for realizing load-side external grounding utilizing connecting busbar of claim 1 is characterized in that: When the static plug (2-1-1) on the static conductor (2-1) of the vacuum interrupter (2) is positioned between the conductor seat (1) and the grounding seat (5), a middle position (i.e. an isolation position and a grounding position) is formed on the three-position switch; a visual grounding fracture is formed on the three-position switch between the static plug (2-1-1) on the static conductor (2-1) and the grounding seat (5).

4. A three-position vacuum switch for realizing load-side external grounding utilizing connecting busbar of claim 1 is characterized in that: The vacuum interrupter (2) is separated from the conductive seat (1) to realize the isolation position, as well as to realize the self-closing under the self-closing forces and to realize the reset after breaking relying on the return spring (8) and the limit spring (9).

5. A three-position vacuum switch for realizing load-side external grounding utilizing connecting busbar of claim 1 is characterized in that: The vacuum interrupter (2) breaking and connecting busbars (4) rotation in realizing of the functions of three-position switch are driven by a driving mechanism.

6. A three-position vacuum switch for realizing load-side external grounding utilizing connecting busbar of claim 3 is characterized in that: The vacuum interrupter (2) is to only withstand the breaking process; the insulating gas is to withstand the power frequency and lightning impulse withstand voltage.
